(19) United States
(12) Patent Application Publication
(10) Pub. No.: US 2024/0046555 A1
(43) Pub. Date: Feb. 8, 2024

(54) Arcuate Imaging for Altered Reality Visualization

(71) Applicant: Gustav LO, Petoskey, MI (US)

(72) Inventor: Gustav LO, Petoskey, MI (US)

(21) Appl. No.: 18/365,140

(22) Filed: Aug. 3, 2023

Related U.S. Application Data
(60) Provisional application No. 63/370,737, filed on Aug. 8, 2022.

(51) Int. Cl. G06T 15/20; G06T 5/50; G06V 10/24; G06V 10/44

(52) U.S. Cl. CPC G06T 15/205; G06T 5/50; G06V 10/24; G06V 10/44; G06V 2201/03; G06T 2207/20221

(57) ABSTRACT

A system includes data processing hardware and memory hardware in communication with the data processing hardware. The memory hardware stores instructions that when executed by the data processing hardware perform operations. The operations include receiving a first image of an object captured by a first image capturing device at a first image capturing location, receiving a second image of the object captured by a second image capturing device at a second image capturing location, and receiving a third image of the object captured by a third image capturing device at a third image capturing location. The first, second, and third images comprise first, second, and third views, respectively. The operations also include generating a three-dimensional (3D) composite image from the first, second, and third images. Each of the first, second, and third image capturing locations are distinct locations that form a convex arc about the object.

### CROSS-REFERENCE TO RELATED APPLICATIONS

This application claims the benefit of U.S. Provisional Application No. 63/370,737 filed Aug. 8, 2022. The entire disclosure of which is incorporated by reference.

### FIELD

The present disclosure relates to altered reality visualization based on arcuate image capturing about a target object.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Augmented reality technology has the ability to alter, or augment, a user's view of the surrounding environment by combining computer-generated images with the user's view of the real world; creating a composite view consisting of both real and virtual elements. Augmented reality offers the user an enriching experience by augmenting, via digital content, the user's perception of their environment and their immediate surroundings. The user may augment their view through various augmented reality devices. These devices are capable of augmenting a user's perception of their environment by, for instance, introducing information about their surroundings, or graphical images to enhance their perception of their current environment.

Another type altered perception of reality is virtual reality. Virtual Reality creates a three-dimensional (3D) computer-generated environment. The user can interact with this environment in a way that feels real using special equipment. Virtual reality allows users to immerse themselves in an entirely virtual world and experience things that would otherwise be very difficult or impossible to do. A user may immerse themselves in a variety of applications ranging from entertainment to business to education.

Virtual and augmented reality can be used in a variety of environments by different types of users to educate each user about their surroundings. For example, a railyard worker can wear augmented reality glasses that allow them to view information about trains in the railyard, or a biologist may use augmented reality to identify different species of plants surrounding them. An astronaut can use virtual reality for learning on Earth how to perform tasks on the International Space Station without having to build a local replica of the space station. Virtual reality and augmented reality technology can be used individually or in combination depending on the application.

One industry that may be ripe for advances in virtual and augmented reality is healthcare. Healthcare professionals, such as doctors and nurses, are in continuous need of technological assistance in order to treat their patients. Particularly, healthcare professionals constantly need to obtain and accumulate data on their patients in order to assess the best treatment plan for the patient. Additionally, healthcare professionals need to educate their patients on the effects that certain procedures will have on the body. Healthcare professionals may be able to show pictures of other patients that have undergone similar procedures, but there is a still a level of disconnect between how a procedure will affect the actual patient. Healthcare professionals would greatly benefit from using augmented reality and/or virtual reality to gather data on their patients and show their patients how they will be affected by different procedures.

### SUMMARY

This section provides a general summary of the disclosure, and is not a comprehensive disclosure of its full scope or all of its features.

One aspect of the disclosure provides a method. The method includes receiving, at data processing hardware, a first image of an object captured by a first image capturing device at a first image capturing location. The first image comprises a first view. The method also includes receiving, at the data processing hardware, a second image of the object captured by a second image capturing device at a second image capturing location. The second image comprises a second view. The method also includes receiving, at the data processing hardware, a third image of the object captured by a third image capturing device at a third image capturing location. The third image comprises a third view. The method also includes generating, by the data processing hardware, a three-dimensional (3D) composite image from the first image, the second image, and the third image. The method further includes generating, by the data processing hardware, a set of reference markers corresponding to features represented by the composite image. The method also includes obtaining, by the data processing hardware, a two-dimensional (2D) reference image representing one or more reference features associated with the features corresponding to the reference markers. The method further includes generating, by the data processing hardware, a three-dimensional (3D) overlay of the reference image by aligning the one or more reference features with locations of the features corresponding to the set of reference markers. The method also includes rendering, by the data processing hardware, a graphical representation of the composite image with the three-dimensional (3D) overlay. Each of the first image capturing location, the second image capturing location, and the third image capturing location are distinct locations that collectively form a convex arc about the object.

Implementations of the disclosure may include one or more of the following optional features. In some implementations, the first image capturing device comprises the data processing hardware.

In some implementations, at least two of the first image capturing device, the second image capturing device, or the third image capturing device are the same image capturing device. The first image capturing device, the second image capturing device, and the third image capturing device may be the same image capturing device.

In some implementations, the features corresponding to the set of reference markers are features on an external anatomical layer of the object. The reference features may represent an internal anatomical layer.

In some implementations, the 3D composite image represents an external anatomical layer of the object. The reference image may represent a 2D internal anatomical layer.

In some implementations, the 3D composite image represents an internal anatomical layer of the object. The reference image may represent a 2D external anatomical layer.

In some implementations, rendering the graphical representation includes overlaying the 3D overlay on the composite image.

In some implementations, the set of reference markers includes a plurality of reference markers.

In some implementations, each of the first image capturing device, the second image capturing device, and the third image capturing device are mobile relative to the object.

Another aspect of the disclosure provides a system. The system includes data processing hardware and memory hardware. The memory hardware is in communication with the data processing hardware and stores instructions that when executed by the data processing hardware perform operations. The operations include receiving a first image of an object captured by a first image capturing device at a first image capturing location. The first image comprises a first view. The operations also include receiving, at the data processing hardware, a second image of the object captured by a second image capturing device at a second image capturing location. The second image comprises a second view. The operations also include receiving, at the data processing hardware, a third image of the object captured by a third image capturing device at a third image capturing location. The third image comprises a third view. The operations also include generating, by the data processing hardware, a three-dimensional (3D) composite image from the first image, the second image, and the third image. The operations also include generating, by the data processing hardware, a set of reference markers corresponding to features represented by the composite image. The operations also include obtaining, by the data processing hardware, a two-dimensional (2D) reference image representing one or more reference features associated with the features corresponding to the reference markers. The operations also include generating, by the data processing hardware, a three-dimensional (3D) overlay of the reference image by aligning the one or more reference features with locations of the features corresponding to the set of reference markers. The operations also include rendering, by the data processing hardware, a graphical representation of the composite image with the three-dimensional (3D) overlay. Each of the first image capturing location, the second image capturing location, and the third image capturing location are distinct locations that collectively form a convex arc about the object.

This aspect may include one or more of the following optional features. In some implementations, the first image capturing device comprises the data processing hardware.

In some implementations, at least two of the first image capturing device, the second image capturing device, or the third image capturing device are the same image capturing device. The first image capturing device, the second image capturing device, and the third image capturing device may be the same image capturing device.

In some implementations, the features corresponding to the set of reference markers are features on an external anatomical layer of the object. The reference features may represent an internal anatomical layer.

In some implementations, the 3D composite image represents an external anatomical layer of the object. The reference image may represent a 2D internal anatomical layer.

In some implementations, the 3D composite image represents an internal anatomical layer of the object. The reference image may represent a 2D external anatomical layer.

In some implementations, rendering the graphical representation includes overlaying the 3D overlay on the composite image.

In some implementations, the set of reference markers includes a plurality of reference markers.

In some implementations, each of the first image capturing device, the second image capturing device, and the third image capturing device are mobile relative to the object.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIGS. 1A and 1B are schematic views of example augmented reality and/or virtual reality environments in accordance with the principles of the present disclosure.

FIG. 2 is a schematic view of an example augmented reality and/or virtual reality system for the augmented reality and/or virtual reality environment of FIGS. 1A and 1B.

FIGS. 3A and 3B are schematic views of example visualizations of a target individual showing the different anatomical layers of the visualizations of a target individual.

FIG. 4 is a flow diagram of an example method of displaying a virtual representation of the target individual.

FIG. 5 is a schematic view of an example electronic device executing instructions for displaying augmented anatomical features in accordance with the principles of the present disclosure.

In the drawings, reference numbers may be reused to identify similar and/or identical elements.

### DETAILED DESCRIPTION

Some of the implementations of the disclosure will be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

Example implementations provide methods, user devices, and systems for displaying a visual representation (e.g., a virtual avatar) of a target individual. An augmented reality/virtual reality (AR/VR) device, such as an AR/VR headset or other electronic device (e.g., a phone, a tablet computing device, or other computer), may be used to display a visual representation with internal and external features that represent the features of the target individual. Particularly, a healthcare professional, such as a doctor or nurse, may use an altered reality device (also referred to herein as an AR/VR device) to view the internal or external anatomical features of the visual representation that represents the target individual, such as a patient. The AR/VR device may project the visual representation onto a display of the AR/VR device such that the anatomical features of the visual representation approximate one or more characteristics (e.g., size, location, shape, etc.) of the target individual's actual anatomical features. For example, the AR/VR device may project the visual representation onto a display of the AR/VR device such that the internal anatomical features are located in an appropriate location of the target individual's actual anatomical features according to the anatomy of the target individual. The visual representation may assist a healthcare professional in more accurately assessing a treatment plan or otherwise treating the patient by enhancing the health care professional's visualization of the patient's body. The visual representation may also show a target individual the effects a procedure could have on the body of the target individual to enhance the target individual's understanding of the medical procedure.

In at least one aspect, the AR/VR device includes a software application configured to identify a plurality of reference markers on the composite image of the patient and to determine an anatomical profile of the target individual based on the plurality of reference markers where the anatomical profile includes a plurality of inner anatomical features. The software application is further configured to display, on the display, a visual representation (e.g., a virtual avatar) of the target individual, wherein the composite image of the target individual is wrapped around the anatomical profile, which contains graphical representations of the inner anatomical features so as to assist in the identification of the inner anatomical features.

In another aspect, a software application includes a list of medical procedures to choose from. The software application may have access to a database populated with a plurality of future state anatomical profiles corresponding to the selected medical procedure, wherein the future state anatomical profile is used in generation of the visual representation (e.g., a virtual avatar), such that the visual representation is a representation of the target individual after the medical procedure has occurred. Accordingly, the AR/VR device displays how the selected medical procedure affects the internal and/or external anatomical features of the patient.

The AR/VR device may also have the capabilities to design a future state for the target individual. That is, not only can the software application associated with the AR/VR device select a medical procedure with a corresponding future state anatomical profile, but the software application is also capable of allowing the user (e.g., the healthcare professional) to configure (e.g., manually configure) the future state of a target individual. For instance, many different medical procedures occur at a particular local site of the human body, but may impact portions of the human body beyond the particular local site. As an example, removing fatty tissue or a mass of cell growth may not only alter a soft tissue region of the body near the site of the removed fatty tissue or mass, but also impact a musculoskeletal layer and/or a skin layer for the patient. For instance, portions of a patient's body (e.g., certain anatomical features) may undergo atrophy, hypertrophy, or hyperplasia due to disease or other conditions of the patient. When a medical procedure occurs, the state of the patient's body (e.g., the atrophy, hypertrophy, or hyperplasia) may change and result in changes to anatomical features that are parts of different systems of the human body. That is, since the body is an organism of interconnected systems, a change or modification to a particular portion of the human body may inevitably cause some modification to other portions (e.g., other systems) of the human body.

The AR/VR device and its corresponding systems include functionality that is capable of representing the impact of changes to the human body (i.e., predict a future physical state and represent that state in the visual representation (e.g., a virtual avatar)). To represent these changes, the visual representation of the target individual may be associated with a plurality of anatomical layers. For instance, the visual representation of the target individual being displayed to the user can be a collection of reference images wrapped in a composite image of the target individual. Here, the reference images graphically represent one or more anatomical features and can each be associated with one or more anatomical layers. For instance, a reference image may depict multiple anatomical features and all of these anatomical features depicted correspond to a single layer and/or each anatomical feature includes its own anatomical layer designation.

By having these anatomical layer associations, the user may be able to toggle on or off a particular anatomical layer to portray the visualization of the target individual in a customizable manner. For instance, the healthcare professional uses the visualization to explain a procedure to a patient or to design a particular procedure. In the case of a plastic surgeon, the plastic surgeon can show a patient that removing fatty tissue in a tummy tuck will have an effect on the patient's body beyond the local site of the fatty tissue. In this example, the plastic surgeon can toggle on a soft tissue layer that results in a visual representation (e.g., a virtual avatar) showing a graphical representation of the soft tissue layer of the patient where the representation of the soft tissue layer is visible and approximates the actual soft tissue of the patient. With the soft tissue layer depicted, the plastic surgeon can modify one or more reference markers on the soft tissue layer of the visual representation to indicate the removal of the fatty tissue of the patient. In response to these modifications input by the plastic surgeon (e.g., changes to one or more reference markers), the system can determine whether these modifications impact other anatomical features associated with other layers of the visualization of the patient. That is, the surgeon makes changes to a particular selected layer and the changes to the selected layer are carried through to other non-selected layers and/or other selected layers. In this respect, after inputting the modifications to the selected layer (e.g., a particular soft tissue layer with the fatty tissue to be removed), the surgeon may toggle off or on layers to illustrate to the patient the predicted effects to the body of the patient.

In addition to being a helpful communication tool between the patient and provider (e.g., the healthcare professional), the system may also enable the healthcare professional to understand how changes he or she may make to a particular local site (e.g., the fatty tissue) will potentially impact other portions of the patient's body. For instance, the healthcare provider designs a procedure that removes a certain portion of soft tissue, but fails to realize that the particular design may cause a potential unintended consequence on the skeletal system of the patient (e.g., results in weakening a muscle sheath associated with a particular bone). By visualizing these changes across all impacted layers, the system is capable of producing a predicted physical future state for anatomical features beyond the directly modified local site. In some examples, the system is configured to represent the changes that automatically occur to other layers and/or to other anatomical features by representing these computer-automated changes in a particular color. For instance, the site of the user-input changes is rendered in red in the virtualization of the target individual and the computer-automated changes predicted to occur based on the user-input changes are rendered in orange in the visualization of the target individual.

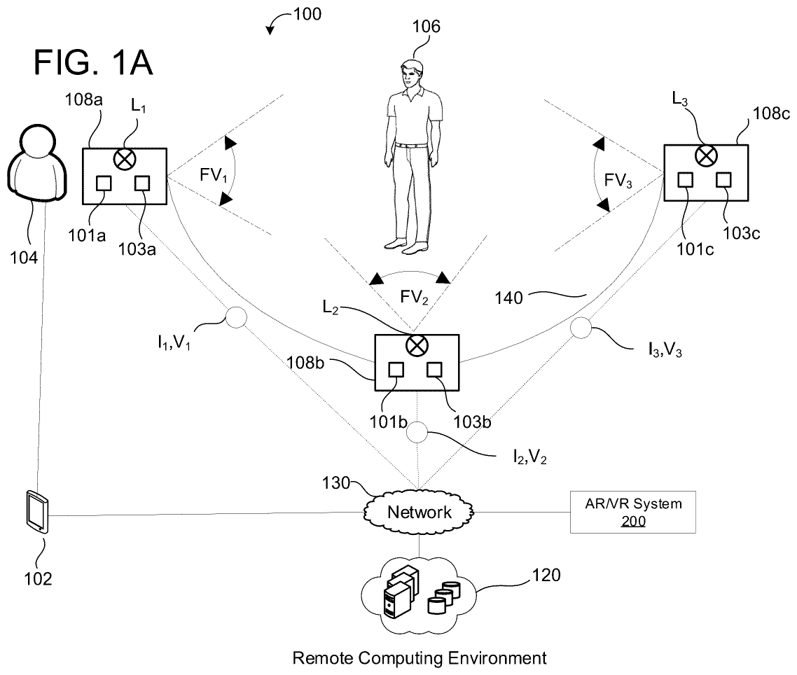

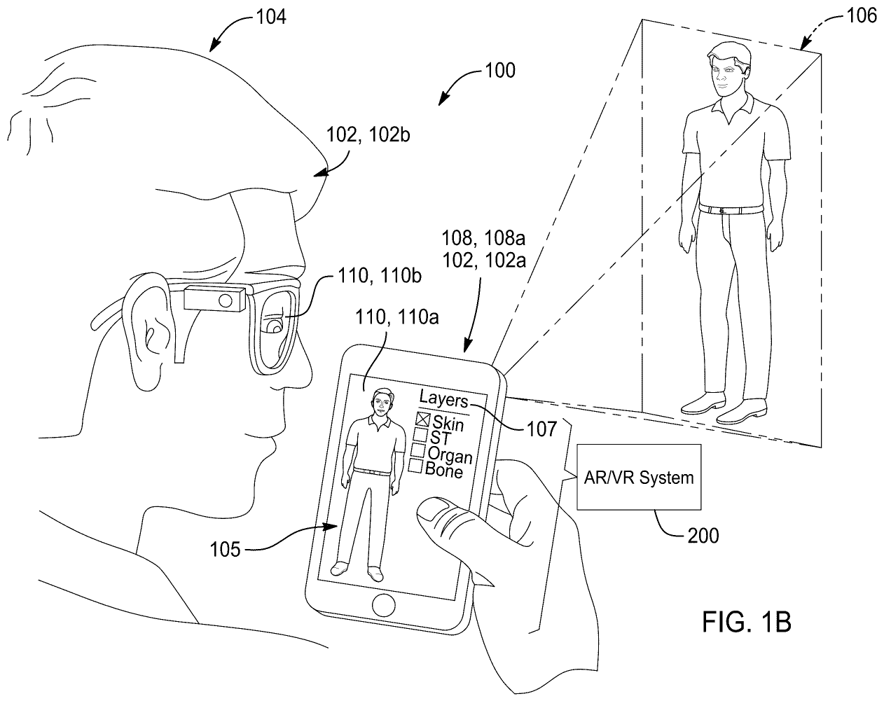

Referring now to FIGS. 1A and 1B, an AR/VR environment 100 generally includes an altered reality device 102 and an image capturing system being used by a user 104 to create a visual representation 105 (e.g., a virtual avatar) of a target individual 106. The altered reality device 102 is a device that may be used to alter a state of reality. As previously discussed, virtual reality (VR) and augmented reality (AR) are two types of altered reality. For that reason, the altered reality device 102 may be an AR device, a VR device, or some combination of both. The altered reality device 102 and the image capturing system (e.g., a first, second, or third image capturing device 108, 108a-c) uses an AR/VR system 200 to display a visual representation 105 corresponding to the target individual 106. The image capturing system may include one or more image capturing devices 108 that capture images I₁₋₃ of the target individual 106 at multiple locations L₁₋₃ such that the locations L₁₋₃ create a convex arc 140 about the target individual 106. For example, the target individual 106 is located at a center of curvature or a focal point corresponding to the arc 140.

The altered reality device 102 and the image capturing system (e.g., the image capturing device 108) are capable of communicating with the AR/VR system 200. In some examples, the altered reality device 102 and/or the image capturing system communicate with the AR/VR system 200 via a network 130. For instance, at least some portion of the AR/VR system 200 is hosted by a remote computing environment 120 and one or both of the altered reality device 102 or the image capturing system are capable of communicating with the AR/VR system 200 by communicating with the remote computing environment 120 (e.g., via the network 130).

As will be described in more detail below, the user 104 may use the altered reality device 102 (e.g., a first or a second altered reality device 102, 102a-b) in an AR/VR environment 100 (e.g., a healthcare environment) to enhance the user's view of the target individual 106. For example, the user 104 may be a doctor, the target individual 106 may be a patient, and the AR/VR environment 100 may be a doctor's office, such that the doctor is able to examine the patient in the doctor's office. While the user 104 is generally shown and described as being a healthcare professional (e.g., a doctor, nurse, physical therapist or trainer, paramedic, medical assistant, pharmacist, etc.), and the target individual 106 is generally illustrated and described herein as being a healthcare patient, the user 104 or target individual 106 may include various other persons within the scope of the present disclosure. For example, the individual 106 may be an athlete, student, or other individual that has a body and is subject to examination or study by another user 104. In this regard, the altered reality device 102 may be used in a wide range of settings by a variety of users 104 to examine a target individual 106 in a variety of environments. The relationship between the altered reality device 102 and the image capturing device 108 of the image capturing system may vary depending on device capability, processing capability, and/or convenience to the entities utilizing these devices 102, 108. For example, in some implementations, such as FIG. 1A, the image capturing device 108 is a separate device from the altered reality device 102. In yet other implementations, such as FIG. 1B, the image capturing device 108 and the altered reality device 102 may be the same device.

The relationship between the altered reality device 102 and the user 104 may vary depending on the layout of the AR/VR environment 100, the needs of or convenience to the user 104, and/or the pose of the target individual 106. Here, “pose” refers to a positional location and/or orientation of the target individual with respect to a particular reference point. For example, in some implementations, such as FIG. 1B, the user 104 (e.g., a medical provider) is holding the altered reality device 102 and capturing an image I of the target individual 106 (e.g., a patient) who is standing. In another implementation, the target individual 106 may be lying down on a table in a supine pose with an altered reality device 102 and/or image capturing device 108 positioned above the target individual 106 capturing images of the target individual 106.

To capture the target individual 106 in various poses (e.g., such as a spline pose), the user 104 may use an altered reality device 102 that is remote from the image capturing system. For instance, the image capturing system communicates one or more views (e.g., a live view of the focal area) of the target individual 106 to the altered reality device 102 (e.g., at a viewport on a display of the altered reality device 102). With these views, the user 104 is capable of orchestrating an image capturing system via the altered reality device 102 to capture the images I of the target individual 106. In some examples, there may be more than one altered reality device 102. For instance, one altered reality device 102 functions as the image capturing system to capture the target individual 106 while another altered reality device 102 locally controls (e.g., at the user 104) the first altered reality device 102 capturing the target individual 106. In this respect, multiple altered reality devices 102 may communicate with one another.

The altered reality device 102 may include (i) an image capturing system, such as an image capturing device 108, and (ii) a visualization system. As will be described in more detail below, during use, the image capture device 108 may obtain data about the environment 100 and, particularly, the target individual 106 located in the environment 100. With data regarding the target individual 106, the display 110 may display, for the user 104 to view, a virtual view of the environment 100 including a visual representation 105 (e.g., a virtual avatar) of the target individual 106 (e.g., generated by the altered reality device 102 and/or accessible to the altered reality device 102). The altered reality device 102 may be any computing device that is capable of executing the functionality of the AR/VR system 200. In this regard, the altered reality device 102 may include data processing hardware 101 and memory hardware 103 executing instructions that cause the data processing hardware to perform the various operations of the AR/VR system 200. Some examples of the altered reality device 102 include a smartphone, tablet computer, smart watch, smart speaker, smart glasses, smart headset (e.g., an AR/VR headset), or other suitable mobile computing device.

In some implementations, such as FIG. 1A, the AR/VR environment 100 includes an image capturing system with a first image capturing device 108a, a second image capturing device 108b, and a third image capturing device 108c. References herein to the image capturing device 108 will be understood to apply equally to the first image capturing device 108a, the second image capturing device 108b, and the third image capturing device 108c. The first image capturing device 108a may be located at a first location L₁ and capture a first image I₁ that represents a first view V₁ of the target individual 106. The second image capturing device 108b may be located at a second location L₂ and capture a second image I₂ that represents a second view V₂ of the target individual 106. The third image capturing device 108c may be located at a third location L₃ and capture a third image I₃ that represents a third view V₃ of the target individual 106. The locations L₁₋₃ of the image capturing devices 108a-c form a convex arc around the target individual 106. For instance, the arrangement of the image capturing system forms a 180 degree arc around the target individual 106 or a 360 degree arc.

Although FIG. 1A depicts three image capturing devices 108 for purposes of illustration, the environment 100 may include any number of image capturing devices 108 that capture images I at locations L about the target individual 106 where the locations L form a convex arc 140. For instance, the environment 100 includes five or ten image capturing devices 108. In some configurations, the environment 100 includes a single image capturing device 108 that is capable of moving to/between locations L to capture the images I of the target individual 106 to form a convex arc of views V about the target individual 106. Each image capturing device 108 may include data processing hardware 101a-c and memory hardware 103a-c executing instructions that cause the data processing hardware 101 to perform the various operations of the AR/VR system 200. The image capturing device 108 may be any device capable of capturing an image I. Some examples of image capturing devices 108 include digital cameras and smartphones. When the image capturing device 108 captures an image I, the image capturing device 108 may also be configured to communicate the image I or some form of image data (also referred to as image data “I” since an image and image data may be used interchangeably herein) corresponding to the image Ito the altered reality device 102. For example, the image capturing device 108 or a set of image capturing devices 108 performs an image capturing routine that generates the plurality of images I of the target individual 106 that form the convex arc 140 about the target individual 106. In some examples, in response to capturing the plurality of images I, the image capturing device(s) 108 communicates the images I to the altered reality device 102 (e.g., for further processing or to enable functions of the AR/VR system 200).

As previously stated, the altered reality device 102 may include a visualization system. The visualization system is a system that is configured to provide a visual representation 105 (e.g., a virtual avatar) to the user 104 associated with the altered reality device 102. In some implementations, the visualization system includes a display 110 to present the visual representation 105 (e.g., a virtual avatar) that represents a composition of the images I captured by the image capturing system. For example, the display 110 receives graphical information from a processor and renders that graphical information as a graphical representation for a user (e.g., the user 104) to visualize. In some configurations, the display 110 may include or be in communication with an input interface (e.g., a touchscreen, a keyboard, a mouse, a microphone, etc.) that enables the user 104 to input data to the altered reality device 102 (e.g., to interact with a graphical representation depicted on the display 110).

In some implementations, the AR/VR environment 100 includes a plurality of altered reality devices 102. For example, FIG. 1B depicts a first altered reality device 102a and a second altered reality device 102b. Here, the first altered reality device 102a is a mobile computing device (e.g., a smartphone or mobile computer) and the second altered reality device 102b is an altered reality headset. References herein to the altered reality device 102 will be understood to apply equally to the first altered reality device 102a and/or the second altered reality device 102b.

The first altered reality device 102a may include an image capture device 108a (e.g., a camera) and a display 110a (e.g., a screen). In some implementations, during use of the first altered reality device 102a, the image capture device 108a captures images I of the environment 100 and, particularly, the target individual 106. Utilizing the captured images I, the display 110a of the first altered reality device 102a may display a composite view of the environment 100 that includes with a visual representation 105 (e.g., a virtual avatar) of the target individual 106. For example, the processor of the first altered reality device 102a generates a composition of images from the captured images Ito generate the visual representation 105 of the target individual 106. In some configurations, an input interface (e.g., a keyboard, mouse, microphone, camera 108a, or touchscreen) of the first altered reality device 102a allows the user 104 to input data to the first and/or the second altered reality device 102a, 102b.

Similar to the first altered reality device 102a, the second altered reality device 102b may include an image capture device 108b (e.g., a camera) and a display 110b (e.g., a screen on an AR/VR headset). During use of the second altered reality device 102b, the image capture device 108b may capture images of the environment 100 and, particularly, the target individual 106. With these captured images, the display 110b may display a composite view of the environment 100, with a visual representation 105 (e.g., a virtual avatar) of the target individual 106. For instance, the processor of the second altered reality device 102b generates a composition of images from the captured images Ito generate the visual representation (e.g., a virtual avatar) of the target individual 106.

In order to receive or to communicate different forms of data, the second altered reality device 102b may include an input interface such as a trackpad, a camera 108b, and/or a microphone. In some examples, the input interface communicates with or includes a detection system that is capable of tracking an object in a field of view. For instance, the detection system includes an eye tracking device or a gesture tracking device. In addition to allowing the second altered reality device 102b to receive data or information from the user 104, the input interface may also enable the second altered reality device 102b to communicate data or information to another device such as the first AR device 102a. For example, the user 104 may input data and otherwise interact with the second altered reality device 102b by touch via trackpad; spoken commands via a microphone; eye gestures via the camera 108b; positional tracking of hands or other body parts via the camera 108b; hand gesture tracking via the camera 108b; or positional tracking of objects such as wands, styluses, pointers, or gloves via the camera 108b.

Though the examples shown depict the altered reality device 102 as a first altered reality device 102a or a second altered reality device 102b, it should be noted that altered reality device 102 may be any device (e.g., AR/VR glasses, AR/VR helmet, tablet, etc.) capable of displaying an avatar representing the target individual 106 in a virtual world.

The altered reality device 102 operating in conjunction with the AR/VR system 200 and the image capturing system is configured to generate a visual representation 105 (e.g., a virtual avatar) of the target individual 106. That is, the image capturing device 108 may capture image data (e.g., via a vision sensor such as a camera) that the visualization system can use (e.g., that can be projected onto the display 110) to represent the actual body of the target individual 106. This visual representation 105 may be the result of one or more two-dimensional (2D) images I capturing the target individual 106 or a visualization of point cloud data captured using one or more cameras associated with the image capturing system. In this respect, the visual representation 105 may be a 3D representation of the target individual 106 such that the visual representation 105 displayed on the display 110 is rotatable/pivot able to other viewing angles to represent a 3D model of the target individual 106.

As shown in FIG. 1B, the first altered reality device 102a includes a display 110a that depicts the visual representation 105 (e.g., a virtual avatar) of the target individual 106. For instance, an application executing the AR/VR system 200 on the altered reality device 102 renders the visual representation 105 in a viewing window within the display 110a. Here, the application includes a layer menu along with the visual representation 105 that indicates one or more anatomical layers 107 associated with the visual representation 105. An anatomical layer 107 refers to one or more anatomical features that have been associated with each other to define a layer. This association may be a known anatomical association (e.g., according to anatomy classifications) or customized by a designer of the application.

Although the anatomical layers 107 may be completely customizable, in some examples, each anatomical layer 107 may correspond to a human body system, subsystem, or some other body-related categorization. For example, the systems of the body are generally the integumentary system, the skeletal system, the muscular system, the nervous system, the endocrine system, the cardiovascular system, the lymphatic system, the digestive system, the urinary system, and the reproductive system. In this respect, a subsystem may correspond to parts of a particular system. For instance, the integumentary system is broken down into three subsystems: a skin layer, a subcutaneous layer, and a dermatomes layer.

In some implementations, the anatomical layers 107 and/or visual representation 105 may be impacted by the pose of the target individual 106 captured by the image capturing system. For instance, if the target individual 106 is positioned in a pose such as a supline pose where the individual 106 is laying down on a table before the image capturing system, this may result in skewing/magnification issues because of the angle of capture or positional frame of the image capturing system. To address and/or enable an enhanced rendering of the target individual 106, the image capturing system and/or AR/VR system 200 may be configured to specifically capture the target individual 106 in a particular pose. For example, the altered reality device 102 may adjust the anatomical layers 107 or the placement of the reference markers 212 based on the identification of the pose (e.g., standing, seated, supine, prone, etc.) of the target individual 106. For instance, the user 104 identifies the pose of the target individual 106 and the AR/VR system 200 adjusts the anatomical layers 107 or the placement of the reference markers 212 by some factor (e.g., a factor accounting for an angle between a reference point of the target individual and a capturing position of an image capturing device 108) associated with the identified pose. In other words, if the target individual 106 is sitting, sitting may compress the abdomen of the target individual 106 which may be accounted for with respect to the rendering of the visual representation 105 and/or the selection/generation of reference markers 212. In some configurations, when the user 104 identifies the pose of the target individual 106, the altered reality device 102 and/or the AR/VR system 200 adjusts components of the image capturing system (e.g., locations of one or more image capturing devices 108) to optimize the images captured to generate the visual representation 105 of the target individual 106.

FIG. 1B illustrates that each layer 107 may be selectively toggled on or off by the user 104. That is, one or more graphical representations corresponding to a layer may be selectively insertable (toggled on) or removable (toggled off) from the visualization of the target individual 106. For instance, in FIG. 1B, an organ layer, a bone layer, and a soft tissue layer are toggled off while a surface layer is togged on (e.g., indicated by an “X”) to depict the clothed target individual 106.

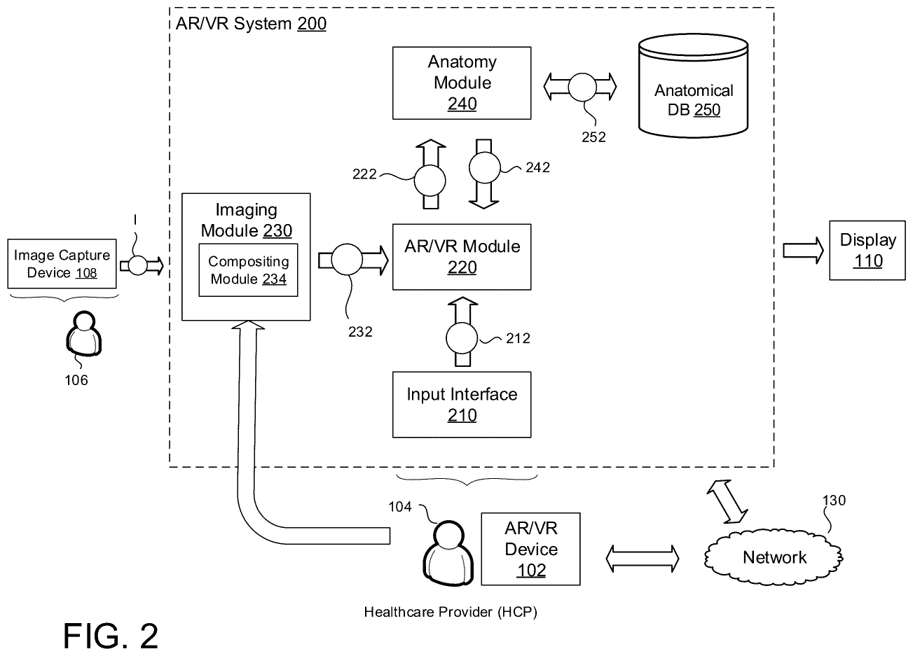

With reference to FIG. 2, the AR/VR system 200 is configured to display or to facilitate (e.g., via the visualization system) the display of the visual representation 105 of the target individual 106. The AR/VR system 200 may be deployed on the altered reality device 102 (e.g., as a local application) or in communication with the altered reality device 102 (e.g., as a remote application hosted on a remote computing device accessible to the altered reality device 102). Generally speaking, the AR/VR system 200 includes an input interface 210, an AR/VR module 220, an imaging module 230, an anatomy module 240, and an anatomical database 250. The imaging module 230 is configured to be in communication with the image capturing system (e.g., at least one image capture device 108) in order to receive image data I corresponding to the target individual 106. In some implementations, such as FIG. 2, the imaging module 230 includes a 3D compositing module 234.

Although FIG. 2 depicts these components of the AR/VR system 200 residing together (e.g., together on the altered reality device 102), in some configurations, some or all of these components of the AR/VR system 200 reside in a location that is remote from the altered reality device 102. For example, one or more components of the AR/VR system 200 reside remotely and in communication with the altered reality device 102 through a wired or wireless communication network 130 (e.g., Wi-Fi, Bluetooth, etc.). In particular, the AR/VR system 200 may include and/or otherwise communicate through a wired or wireless network 130 that provides access to the altered reality device 102 and that provides for the performance of services on remote devices. Accordingly, the network 130 may allow for interaction between the user 104 using the altered reality device 102 and the AR/VR system 200. For instance, the network 130 may provide the user 104 access to the AR/VR system 200 in order for the AR/VR system 200 to receive data input by the user 104 (e.g., input by an interaction with the altered reality device 102). In turn, the AR/VR system 200 may store data in a storage resource (e.g., memory) on the altered reality device 102 or accessible via the network 130 (e.g., a server in communication with the network 130).

As will be described in more detail below, the AR/VR system 200 may provide the user 104 (e.g., a healthcare provider) with the ability to enhance the user's view of a target individual 106. In this regard, the altered reality device 102 may include data processing hardware (e.g., a computing device that executes instructions), memory hardware, and the display 110 in communication with the data processing hardware and/or memory hardware.

The input interface 210 may provide the user 104 access to, and the ability to interact with, the AR/VR module 220 through the altered reality device 102. In some examples, the input interface 210 is able to receive input (e.g., a user-generated input) from a keyboard, touchpad, mouse, microphones, eye-tracking device, gesture tracking device, and/or a camera in order to enable the user 104 to input data to the AR/VR system 200. In some examples, in addition to, or in lieu of, the display 110, the altered reality device 102 may include one or more speakers to output audio data to the user 104.

In some implementations, the user 104 interacts with the input interface 210 by inputting data corresponding to reference markers 212. The reference markers 212 may correspond to locations on the target individual 106. For example, the reference markers 212 may be designated by the user 104 to indicate a reference location on a 2D or 3D projection of the target individual 106. As an example, the user 104 may identify a particular pixel or pixel area in an image (e.g., by tapping, touching, or somehow selecting) to place a reference marker 212 at a virtual location in the image that corresponds to an anatomical location on the target individual 106. That is, if the user 104 selects a pixel at the location where the image depicts the tenth rib of the target individual 106, the AR/VR system is configured to place a reference marker 212 on the target individual 106 at tenth rib.

In some example, the reference markers 212 are associated with a coordinate system. For instance, an origin point may be automatically designated or set by the user 104. With a set origin point (e.g., local origin with respect to a particular image or global origin with respect to the environment 100), when the user 104 indicates a reference location for a reference marker 212, the input interface 210 (or some other component of the AR/VR system 200) may assign the reference location to the reference marker 212 as a coordinate location with respect to the set origin point. In this respect, the reference markers 212 may include coordinate locations (e.g., two dimensional or three dimensional coordinates). By having corresponding coordinates, the reference markers 212 may be translated or updated as, for example, composite images are formed or modifications are made to the reference markers 212.

Data corresponding to the reference markers 212 (e.g., coordinates of the reference markers 212) may be sent to the AR/VR module 220. The AR/VR module 220 may communicate with the anatomy module 240. For instance, the AR/VR module 220 may send anatomical data 222 corresponding to the reference markers 212 to the anatomy module 240. The AR/VR module 220 may then request reference image files 252 from the anatomical database 250 corresponding to the anatomical data 222 received by the anatomy module 240. The anatomy module 240 may then retrieve reference image files 252 corresponding to the anatomical data 222, a future state anatomical profile, or a preferred anatomical profile from the database 250. In some examples, the anatomy module 240 may then generate an anatomical profile 242 from a set of reference image files and/or modifications to reference image files 252, including graphical representations of anatomical features, to be sent to the AR/VR module 220.

As an example, the anatomical database 250 may be populated with a discrete number of reference image files 252. In some implementations, the reference image files 252 may include medical images (e.g., MRI scans, CT scans, X-rays, ultrasound, etc.) of the target individual 106, generic medical images, and non-medical images that may be generic, specific to the target individual 106, or some combination of both. The medical images may have anchored anatomical reference markers 212 that correspond to reference markers 212 input into the input interface 210 or otherwise recognized by the AR/VR system 200. Some of these reference image files 252 may have prepopulated reference markers 212. For example, a medical provider may have annotated specific aspects of the medical images of the target individual and the AR/VR system 200 recognizes or converts these annotations to prepopulated reference markers or suggested/candidate reference markers. In other examples, the user 104 may load a reference image file 252, such as a medical image, and designate reference markers 212 using the reference image file 252 to define reference markers 212 at precise anatomical locations. Reference markers 212, such as the anchored anatomical reference markers 212, may allow medical images as the reference image files 252 to be more precisely matched to the target individual 106. By enhancing the ability to match actual anatomical features of the target individual 106, the skewing or magnification issues that inherently come with using a generic image file may be avoided.

Each reference image file 252 may correspond to one or more characteristics (e.g., age, height, weight, gender, race, shape, etc.) of an individual (e.g., target individual 106). In such an aspect, the altered reality device 102 may process the reference markers 212 and/or other data inputted into the input interface 210, to automatically select a reference image file 252 that best matches the characteristics (e.g., location, spacing, etc.) of the reference markers 212 and/or other data input into the input interface 210. In other implementations, the user 104 may select a reference image file 252 that best matches the reference markers 212 and/or other data input into the input interface 210. For instance, the target individual 106 may be a male adult that is 5′11″. The anatomical database 250 may be populated with reference image files 252 corresponding to a male adult that is 5′8″ and other reference image files 252 corresponding to a male adult that is 6′2″. The AR/VR system 200 may select the reference image file 252 of the adult male that is 6′2″ in cases where the anatomical profile of the adult male that is 6′2″ matches the reference markers 212 more closely than the anatomical profile of the adult male that is 5′8″. For example, the anatomical features of the reference markers 212 projected on the anatomical profile of the adult male that is 6′2″ more closely align (e.g., by distance) with the actual anatomical features of the 6′2″ adult male than the anatomical features of the reference markers 212 projected on the anatomical profile 242 of the adult male that is 5′8″.

In some implementations, the AR/VR system 200 searches the anatomical database 250 to find an anatomical profile 242 corresponding to the reference markers 212. For example, the AR/VR system 200 may use the distance between reference markers 212 to find an anatomical profile 242 having similar distances between the reference markers 212. For example, if the patient is a male, that is 5′10″ having the left and right shoulders that are spaced apart from each other 18 inches, the left and right hips that are spaced apart from each other 19 inches, the AR/VR system 200 searches the anatomical database 250 to find reference image files 252 of a male that is 5′10 having reference markers 212 of similar spacing. It should be appreciated that any number of reference markers 212 may be used to determine the corresponding anatomical profile 242 including reference markers 212 beyond or other than the left and right shoulders and the left and right hips.

As will be explained in more detail below, in another aspect, the AR/VR system 200 may be further configured to scale the anatomical profile 242, based upon the characteristics of the target individual 106 relative to the reference image files 252. The AR/VR system 200 may make a determination that the target individual 106 is larger or smaller than the selected reference image files 252. The AR/VR system 200 may be further configured to increase or decrease the size of the inner anatomical features associated with the selected reference image files 252 so as to fit the reference markers 212 and/or other characteristics of the target individual 106. As an example, for a target individual 106 that is larger than the selected reference image files 252, the reference image files 252 may be enlarged. For instance, if the reference markers 212 indicate a shoulder spacing of 18 inches and the anatomical profile of the reference image file 252 has a shoulder spacing of 16.5 inches, the inner anatomical features may be scaled (e.g., enlarged) by a factor of 18/16.5=1.091. In some implementations, the anatomical profile 242 may be customizable to the target individual 106 by inputs from the user 104. For example, the user 104 may change the location of certain reference markers 212 on the anatomical profile to better represent the dimensions of the target individual 106.

The imaging module 230 may communicate with at least one image capturing device 108 to receive image data corresponding to the target individual 106. In some examples, the imaging module 230 includes a composite module 234 that is configured to generate a composite representation of the target individual 106 (e.g., from one or more images I or a set of image data). For example, in some configurations, the composite module 234 obtains image data corresponding to the target individual 106 and uses the obtained image data to create a virtual 3D representation of the target individual 106. The image data may be data corresponding to the current real world view captured by the image capture system (i.e., a field of view of the image capture device 108).

In some examples, when the composite module 234 receives image data, the image data includes one or more reference markers 212. In some implementations, the composite module 234 generates a 3D composite image 232 from the obtained image data to form the 3D representation of the target individual 106. Here, when the image data includes reference markers 212, the composite module 234 may generate the 3D composite image 232 with the included reference markers 212. For instance, when the reference markers 212 are two dimensional reference markers 212 (e.g., refer to a two-dimensional coordinate space) corresponding to a particular image I, the composite module 234 translates the reference markers 212 to the three dimensional space represented by the composite image 232.

In some configurations, to perform this 2D to 3D translation of the reference markers 212, the composite module 234 identifies relational characteristics between the images I forming the composite image 232. For example, the composite module 234 determines an angle between locations L where image capturing device(s) 108 captured the images I used to form the composite image 232. With the relational characteristics, the composite module 234 may then project 2D reference markers 212 into the 3D space represented by the composite image 232.

In some examples, the reference markers 212 from a first image I forming the composite image 232 are the same reference markers 212 from a second image I forming the composite image 232. In this sense, relational data about these images I (e.g., location of capture, height of capture, spatial coordinates of the image capturing device 108 at the time of capture, etc.) provides relationship data that allows the AR/VR system 200 to track the reference markers 212 in 3D space such that the reference markers 212 can anchor to an augmented reality representation of the target individual 106 or a completely virtual representation of the target individual 106.

In some configurations, the composite module 234 generates a 3D composite image 232 from a set of 2D images I whose image data does not include reference markers 212. To complete the generation of a visual representation 105 of the target individual 106, reference markers 212 may be anchored on the 3D composite image 232 after the 3D composite image 232 is generated. In some implementations, the user 104 interacts with the input interface 210 by inputting data corresponding to reference markers 212. The reference markers 212 may correspond to locations on the target individual 106. For example, the reference markers 212 may be designated by the user 104 to indicate a reference location on the 3D composite image 232 of the target individual 106. As an example, the user 104 may identify a particular pixel or pixel area in an image (e.g., by tapping, touching, or somehow selecting) to place a reference marker 212 at a virtual location in the image that corresponds to an anatomical location on the target individual 106. That is, if the user 104 selects a pixel at the location where the image depicts the tenth rib of the target individual 106, the AR/VR system is configured to place a reference marker 212 on the target individual 106 at tenth rib.

The AR/VR module 220 is configured to generate a graphical representation that portrays a 3D form of the target individual 106 with anatomical features beyond what is captured by the image capturing device. In other words, the 3D composite image represents a 3D form of the target individual 106. Yet the 3D composite image is typically going to be a surface view of the target individual 106. That is, the images forming the 3D composite image 232 are images of an exposed surface or layer of the target individual 106 at the time of image capture. Generally speaking, this means that the images I likely capture the target individual 106 in a clothed state or some form of an exposed state showing the skin layer of the target individual 106. To provide a anatomical context which is greater than simply the 3D composite image 232, the AR/VR module 220 is configured to performs graphical processing that introduces anatomical features not necessarily represented by the 3D composite image 232.

In some examples, the AR/VR module 220 generates the graphical representation (e.g., the visual representation 105) using the 3D composite image 232 and a 2D reference image representing one or more reference features associated with the features indicated by the reference markers 212 identified for the target individual 106. In these examples, the AR/VR module 220 obtains the 2D reference image (e.g., from the anatomy module 240) which contains reference features (e.g., 2D features) that correspond to features identified by reference markers 212 specific to the target individual 106 and generates a 3D overlay of the 2D reference image by aligning the one or more reference features represented in the 2D reference image with locations of features corresponding to the reference markers 212 identified for the target individual 106. In other words, the AR/VR module 220 is capable of identifying anatomical features included in a 2D reference image that correspond to actual anatomical features identified by reference markers 212 for the target individual.

As previously mentioned, the AR/VR module 220 may be configured to receive the anatomical profile 242 from the anatomy module 240 and the 3D composite image 232 from the composite module 234. Since the anatomical profile 242 is a profile for the target individual 106 that includes one or more reference image files 252 that have been adapted to correspond to reference markers 212 identified for the target individual 106, the anatomical profile 242 may be used by the AR/VR module 220 to function as the 2D reference image that the AR/VR module 220 uses to generate the graphical representation. In other words, if the anatomical profile 242 is generated for target individual 106 prior to the generation of the graphical representation by the AR/VR module 220, the AR/VR module 220 can leverage the anatomical profile 242 to obtain a 2D reference image representing one or more reference features associated with the features indicated by the reference markers 212.

The AR/VR module 220 may generate any number of 3D overlays to construct 3D anatomical features on the 3D composite image 232. For example, the anatomical profile 242 of the target individual 106 may include several reference image files 252 which have been two-dimensionally adapted according to the reference markers 212 of the target individual 106 (e.g., the reference markers 212 associated with the 3D composite image 232). Each of these adapted reference image files 252 that are then specific to the target individual 106 may be converted to 3D overlays by the AR/VR module 220 in a similar manner. In other words, to generate a final visualization of the target individual 106 that may include multiple layers 107, the AR/VR module 220 is configured to modify as many reference image files 252 as necessary to construct the multi-layer visualization (e.g., the visual representation 105) of the target individual 106. With this approach, the visual representation 105 may contain internal and external anatomical features that accurately represent the actual anatomical features of the target individual 106. The AR/VR module 220 of the AR/VR system 200 may communicate with the altered reality device 102 such that the visualization system (e.g., a display 110) may render the graphical representation of the 3D composite image 232 with one or more 3D overlays to form the visual representation 105.

Additionally, the AR/VR module 220 may apply the same modifying functionality to an anatomical profile 242 that represents a future state (e.g., a post-surgery state) of the target individual 106. That is, the user 104 may make changes to reference markers 212 to simulate a change to the body of the target individual 106. To enable this simulation, the AR/VR module 220, based upon the reference marker changes, updates the anatomical profile 242 by scaling the reference image files 252 to reflect the reference marker changes. Therefore, the AR/VR module 220 is able to constantly modify the visual representation 105 (e.g., a virtual avatar) (e.g., based on user inputs).

In addition to making changes to reference markers 212 to simulate a change to the body of the target individual 106, the user 104 may command the AR/VR module 220 to modify the visual representation 105 in many other ways. In some implementations, the visual representation 105 shows more than one anatomical layer 107 of the target individual 106, the user 104 may change the opacity of one or more of the anatomical layers 107. For example, the visual representation 105 may show a muscle layer, a bone layer, and a vascular layer. The user 104 may lower the opacity of the muscle layer to be able to see the bone layer and the vascular layer underneath the muscle layer. The user may change the opacity of any part of the visual representation 105 by interacting with the altered reality device 102 (e.g., adjusting a slider on the display 110 or by hand gesture).

In other implementations, the user 104 may modify the visual representation 105, for example, by changing the size or location of an organ or removing the organ all together by hand gesture. For example, if the user 104 wants to show the target individual 106 the effect of removing a kidney, the user 104 may “grasp” (e.g., by hand gesture) the part of the visual representation 105 that represents the kidney and remove it from the visual representation 105 by a second hand gesture. In addition to, or separately from, the modifications previously described, the user 104 may label parts of the visual representation 105 through voice commands, hand gestures, or other user-generated input. While certain types of modifications and ways of implementing though modifications have been described in detail, it should be appreciated that other modifications and combinations of modifications to the visual representation 105 can be implemented without straying from the disclosed material.

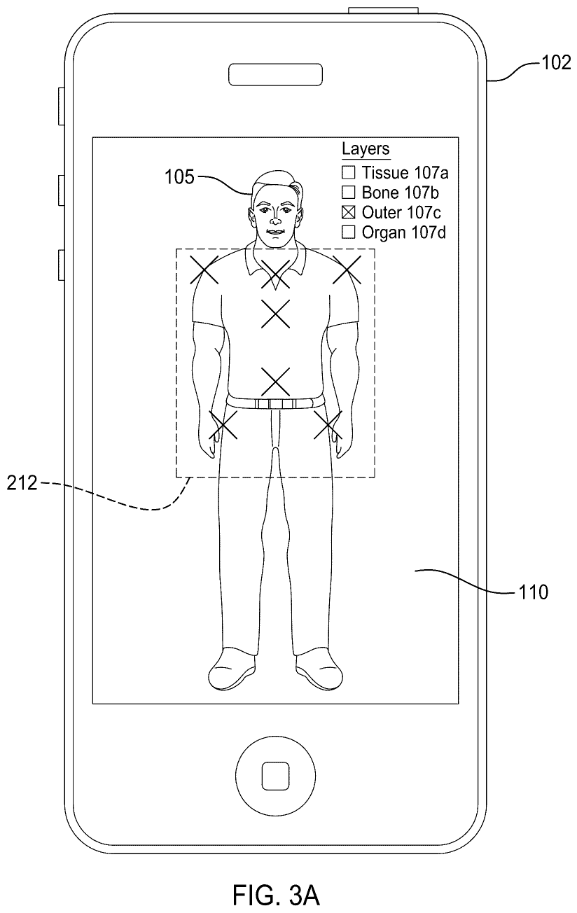

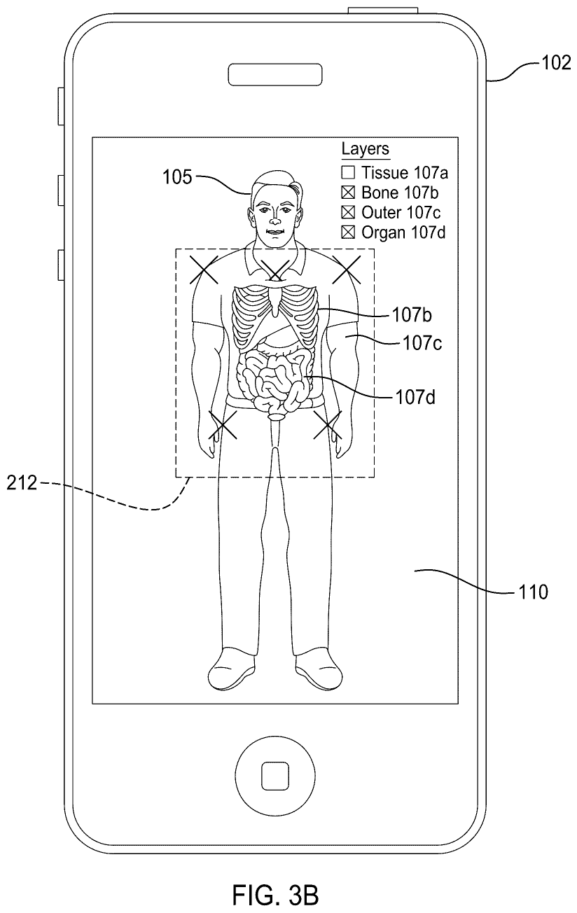

FIGS. 3A and 3B are examples of the visual representation 105 (e.g., a virtual avatar) of the target individual 106 rendered at the display 110 of the altered reality device 102. While FIGS. 3A and 3B show the altered reality device 102 as a smartphone, it is understood that the altered reality device 102 can be any device capable of rendering the visual representation 105. As described above, the visual representation 105 may be generated by aligning the reference markers 212 of the 3D composite image with 3D overlays representing the anatomical features of the anatomical profile 242. The reference markers 212 may be associated with one or more anatomical layers 107.

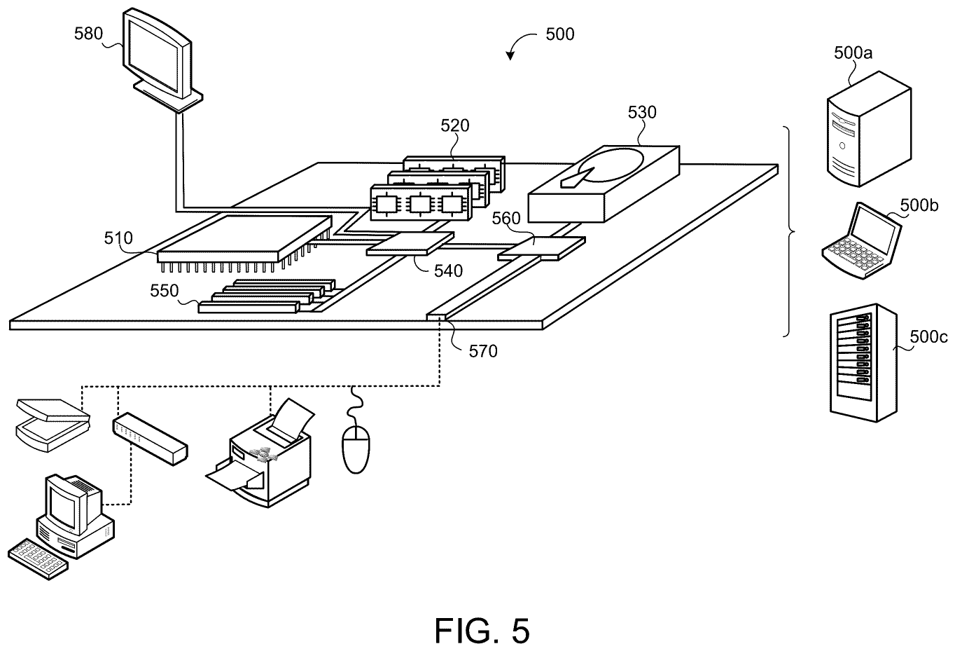

In some examples, to display the visual representation 105 (e.g., a virtual avatar), the AR/VR system 200 identifies one or more reference markers 212 (e.g., based on received inputs at the altered reality device 102). For example, the user 104 designates pixel locations on the display 110 and the anatomical features at the pixel location is designated a reference marker 212. The AR/VR system 200 may also determine the distance from each reference marker 212 to each of the other reference markers 212 and transmit data corresponding to the distances to a processor (e.g., processor 510 of FIG. 5). The AR/VR system 200 may further perform a look up in a database (e.g., database 250 in FIG. 2) with data corresponding to reference markers 212 (e.g., memory 520 of FIG. 5). The altered reality device 102 may use the data corresponding to reference markers 212, and in some implementations the plurality of target data, to determine data corresponding to the anatomical features' characteristics (e.g., size, location, etc.). For example, the AR/VR system 200 may use the reference markers 212 and the 3D composite image 232 of the target individual 106 created from image data captured by the image capturing device 108 to create the visual representation 105 of the target individual 106. In particular, the altered reality device 102 (e.g., via the AR/VR system 200) may transmit the data corresponding to the anatomical features' characteristics to the processor (e.g., processor 510 of FIG. 5) and display the visual representation 105 on the display 110 at a location corresponding to the target individual 106 (see FIG. 1B).

Referring now to FIGS. 3A and 3B the altered reality device 102 may identify (e.g., assign) one or more reference markers 212 on the visual representation 105 (e.g., a virtual avatar) of the target individual 106. For example, the altered reality device 102 displays the 3D composite image 232 and the user 104 identifies the reference markers 212 on the 3D composite image 232. Each reference marker 212 may correspond to a particular part of, or location on, the body of the target individual 106. By being associated with a particular anatomical feature of the target individual 106, a reference marker 212 may also be associated with an anatomical layer 107 corresponding to that particular anatomical feature.

As an example, FIG. 3A depicts a reference marker 212 on each shoulder of the target individual 106. If the reference marker 212 was placed at the shoulder on the scapula, that reference marker 212, in referring to a bone, may be assigned to a layer 107 corresponding to the skeletal system (i.e., a layer 107 that includes the scapula bone). In contrast, if the reference marker 212 was placed at the rotator cuff, the reference marker 212 may be assigned a layer 107 corresponding to muscles/tendons such as a soft tissue layer 107. In some configurations, when the placement of the reference marker 212 may correspond to different anatomical features at or in close proximity to the placement location, the user 104 may be prompted by the AR/VR system 200 to request that the user 104 specifies which specific anatomical feature was the intended target of the placement. For instance, in the example of the shoulder, the user 104 receives a prompt that requests the user 104 to indicate whether the reference marker 212 was intended for the rotator cuff or the scapula.

Once the AR/VR system 200 determines the target anatomical feature of the reference marker 212, the AR/VR system 200 may assign a reference marker 212 to the anatomical layer 107 corresponding to the target anatomical feature for which it identifies. In some examples, instead of actively assigning the reference marker 212 to the anatomical layer 107, the AR/VR system 200 is configured to have the reference marker 212 inherently assume the anatomical layer 107 corresponding to the target anatomical feature as a property of the reference marker 212.

In some implementations, the altered reality device 102 assigns the reference marker(s) 212 by detecting an input (e.g., touch, hand gesture, etc.) from the user 104 (e.g., at an input interface or detection system) corresponding to one or more particular parts of the body of the target individual 106. In particular, the reference markers 212 may be identified by the user's interaction with the altered reality device 102. For example, in some implementations, the user 104 touches the display 110a at locations corresponding to each reference marker 212. In other implementations, the altered reality device 102b receives an input from the user 104 via the camera 108b, or the trackpad 111 corresponding to each reference marker 212. For example, the camera 108b may capture the location of the user's hand at locations corresponding to each reference marker 212.

In some implementations, the altered reality device 102 recognizes and assigns the reference marker(s) 212 to one or more particular parts of the body (e.g., facial features) of the target individual 106. In this respect, the reference markers 212 are capable of being computer-generated in addition or in alternative to being user-designated (i.e., manually assigned by the user 104). For example, the image capturing device 108 may include an infrared camera that uses infrared laser scatter beam technology, for example, to recognize and assign the reference markers 212 to the one or more particular parts of the body (e.g., facial features) of the target individual 106. In particular, the image capturing device 108 may be able to create a three-dimensional reference map of the face of the target individual 106 and compare the three-dimensional reference map to reference data stored in a storage resource of the altered reality device 102, such as the storage device 530 (FIG. 5). The altered reality device 102 may use the infrared camera of the image capturing device 108 to identify the reference markers 212 on the face of the target individual 106. The altered reality device 102 may identify the reference markers 212 on the lips, corners of the mouth, tip of the nose, or ears of the target individual 106. For example, the altered reality device 102 may identify the reference markers 212 based on input (e.g., touch, hand gesture, etc.) from the user 104. As will be explained in more detail below, in some implementations, the altered reality device 102 uses the identification information from the infrared camera, along with the identified referenced markers 212 based on the input from the user 104, to transmit data corresponding to the location of the reference markers 212 to a processing module (e.g., processor 510 of FIG. 5) to allow the altered reality device 102 to advantageously give more individualized and specific estimates of the location of various anatomical features on the body (e.g., face) of the target individual 106, including the underlying blood vessels, nerves, and muscles.

In some implementations, the altered reality device 102 identifies and assigns the reference marker(s) 212 by using machine learning or artificial intelligence algorithms to identify particular parts of the body of the target individual 106. The altered reality device 102 may assign the locations of the reference markers 212 on the target individual 106 based on the locations of similar reference markers 212 on one or more other target individuals 106. The altered reality device 102 may use machine learning or artificial intelligence algorithms to identify the target individual 106 as being a human body by detecting a silhouette of the target individual 106, recognizing body parts of the detected silhouette (e.g., limbs, crotch, armpits, or neck), and then determining the location of, and assigning, reference markers 212 based on the recognized body parts. In this regard, in some implementations, the altered reality device 102 may prompt the user to identify one or more particular reference points (e.g., body parts) on the target individual 106 prior to determining the location of, and assigning, reference markers 212 based on those body parts. In some configurations, the altered reality device 102 may utilize a scanning technology (e.g., laser imaging, detection, and ranging (Lidar), ultrasound, computed tomography, etc.) to identify one or more particular reference points (e.g., body parts) on the target individual 106 prior to determining the location of, and assigning, reference markers 212 based on those body parts.

In some examples, the reference markers 212 and/or other anatomical data captured about the target individual 106 may be used by the AR/VR system 200 to generate an anatomical profile 242 of the target individual 106. The anatomical profile 242 may include a plurality of characteristics corresponding to the individual 106. In some implementations, the anatomical profile 242 includes or is based on a plurality of target data, such as age or sex of the target individual 106. In some implementations, the altered reality device 102 determines the anatomical profile 242 based on an input (e.g., touch, hand gesture, etc.) from the user 104. In other implementations, the altered reality device 102 uses machine learning or artificial intelligence algorithms to determine the anatomical profile 242.

FIG. 3B is similar to FIG. 3A except that different anatomical layers 107 are active in FIG. 3A compared to FIG. 3B. That is, FIG. 3A depicts the visual representation 105 of the target individual 106 as a graphical representation of an outer layer 107c. In other words, FIG. 3A illustrates the AR/VR system 200 with the altered reality device 102 rendering a display of the target individual 106 being clothed such that all other layers 107 besides the outer layer 107c have been toggled off (e.g., by the user 104 or as an initial default view). In contrast, FIG. 3B shows that three layers 107 are toggled on. Namely, the outer layer 107c, the soft tissue layer 107a, and the bone layer 107b are active. With these layers 107 active, the user 104 can view or visualize inner anatomical features shown as a graphical representation of the target individual 106.

As described above, by modify the locations of the reference markers 212, the visual representation 105 (e.g., a virtual avatar) may be modified. The reference markers may be modified by input from the user 104 that moves the location of the reference markers 212. For example, the user 104 may, by using gestures (e.g., hand gestures), take one or more of the identified reference markers 212 associated with the reference images 252 (e.g., medical images) and adjust the reference markers 212 to fit the target individual 106 as the target individual is in the AR/VR environment 100 in front of the user 104. In other implementations, the AR/VR system 200 may modify the reference markers based on an ideal future state anatomical profile. In this respect, the visual representation 105 is updated to reflect the ideal future state. The ideal future state may reflect a change in the body of the target individual 106. For example, the ideal future state, based on a change in the location of one or more reference markers 212 indicates future weight loss, future weight gain, or future medical or cosmetic procedure (e.g., implant, removal, movement, etc. of material and/or part of the body of the target individual 106) that the target individual 106 will, or desires to, undergo.

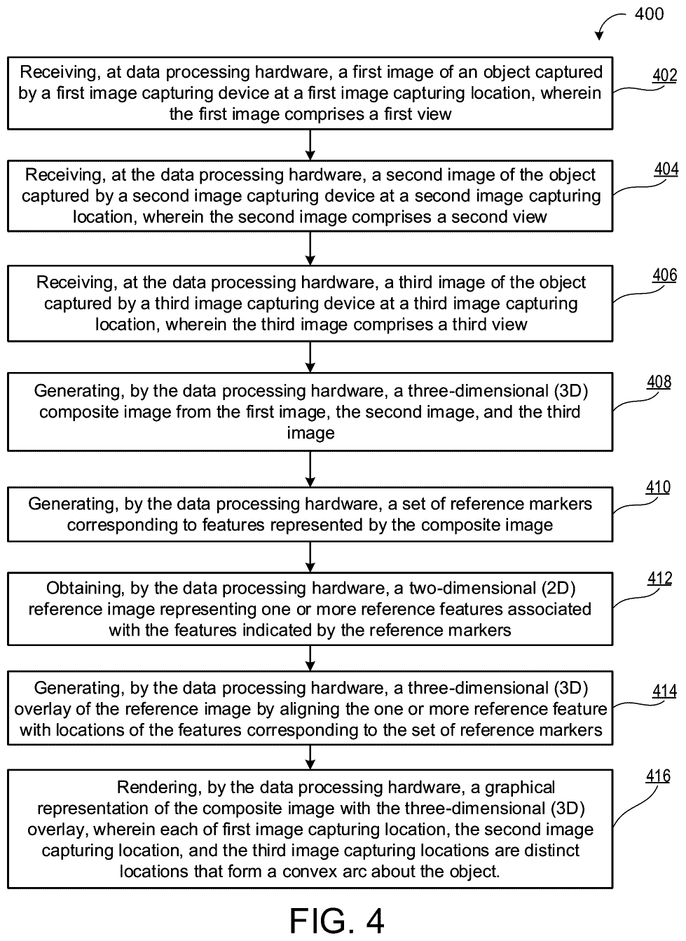

FIG. 4 is a flow chart illustrating a method 400 for displaying augmented anatomical features in accordance with an example implementation of the disclosed technology. At operation 402, the method 400 receives, a first image of an object captured by a first image capturing device at a first image capturing location, wherein the first image comprises a first view. At operation 404, the method 400 receives a second image of the object captured by a second image capturing device at a second image capturing location, wherein the second image comprises a second view. At operation 406, the method 400 receives a third image of the object captured by a third image capturing device at a third image capturing location, wherein the third image comprises a third view. At operation 408, the method 400 generates a three-dimensional (3D) composite image from the first image, the second image, and the third image. At operation 410, the method 400 generates a set of reference markers corresponding to features represented by the composite image. At operation 412, the method 400 obtains a two-dimensional (2D) reference image representing one or more reference features associated with the features indicated by the reference markers. At operation 414, the method 400 generates a three-dimensional (3D) overlay of the reference image by aligning the one or more reference feature with locations of the features corresponding to the set of reference markers. At operation 416, the method 400 renders a graphical representation of the composite image with the three-dimensional (3D) overlay.

FIG. 5 is schematic view of an example computing device 500 that may be used to implement the systems (e.g., the AR/VR system 200) and methods (e.g., method 400) described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The network may include any type of network that allows sending and receiving communication signals, such as a wireless telecommunication network, a cellular telephone network, a time division multiple access (TDMA) network, a code division multiple access (CDMA) network, Global system for mobile communications (GSM), a third generation (3G) network, fourth generation (4G) network, a fifth generation (5G) network a satellite communications network, and other communication networks. The network 130 may include one or more of a Wide Area Network (WAN), a Local Area Network (LAN), and a Personal Area Network (PAN). In some examples, the network includes a combination of data networks, telecommunication networks, or a combination of data and telecommunication networks. An augmented reality/virtual reality device 102 and augmented reality/virtual reality module 200 communicate with each other by sending and receiving signals (wired or wireless) via the network 130. In some examples, the network 130 provides access to cloud computing resources, which may be elastic/on-demand computing and/or storage resources available over the network 130. The term ‘cloud’ services generally refers to a service performed not locally on a user's device (e.g., device 102), but rather delivered from one or more remote devices accessible via one or more networks 130.

The memory 520 stores information non-transitorily within the computing device 500. The memory 520 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Among other advantages, the present disclosure provides methods, user devices, and systems for displaying a visual representation 105 (e.g., a virtual avatar) that represents the external and internal features of the target individual. An augmented reality/virtual reality device may display the visual representation 105 that externally looks like the target individual and internally illustrates an approximation of the structures, tissues or organs that lie beneath the surface of an individual, such as a target individual, in front of a user, such as a healthcare professional. The user may use the augmented reality/virtual reality device to identify certain anatomical reference points on the body of the target individual, and use those points to combine the captured images with the reference images. The reference images may be representative of human anatomy of a human of similar age, sex, etc.

Among other advantages, the present disclosure also provides a method, user device, and system that may be for general use. In this regard, use of the augmented reality device may not be restricted to certified healthcare providers. Furthermore, the expectation of the augmented reality device may be to output or display a computer-generated approximation of a representative human anatomy.

Among other advantages, the present disclosure also provides broad applicability. The augmented reality device may be in constant and rapid use with one target individual after another, and without requiring the input of outside data.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The following Clauses provide an exemplary configuration for an altered reality visualization system and related methods, as described above.

Clause 1: A method comprising: receiving, at data processing hardware, a first image of an object captured by a first image capturing device at a first image capturing location, wherein the first image comprises a first view; receiving, at the data processing hardware, a second image of the object captured by a second image capturing device at a second image capturing location, wherein the second image comprises a second view; receiving, at the data processing hardware, a third image of the object captured by a third image capturing device at a third image capturing location, wherein the third image comprises a third view; generating, by the data processing hardware, a three-dimensional (3D) composite image from the first image, the second image, and the third image; generating, by the data processing hardware, a set of reference markers corresponding to features represented by the composite image; obtaining, by the data processing hardware, a two-dimensional (2D) reference image representing one or more reference features associated with the features indicated by the reference markers; generating, by the data processing hardware, a three-dimensional (3D) overlay of the reference image by aligning the one or more reference feature with locations of the features corresponding to the set of reference markers; and rendering, by the data processing hardware, a graphical representation of the composite image with the three-dimensional (3D) overlay, wherein each of the first image capturing location, the second image capturing location, and the third image capturing location are distinct locations that collectively form a convex arc about the object.

Clause 2: The method of clause 1, wherein the first image capturing device comprises the data processing hardware.

Clause 3: The method of any of clauses 1 through 2, wherein at least two of the first image capturing device, the second image capturing device, or the third image capturing device are the same image capturing device.

Clause 4: The method of any of clauses 1 through 3, wherein first image capturing device, the second image capturing device, and the third image capturing device are the same image capturing device.

Clause 5: The method of any of clauses 1 through 4, wherein: the features corresponding to the set of 3D reference markers are features on an external anatomical layer of the object; and the reference features represent an internal anatomical layer.

Clause 6: The method of any of clauses 1 through 5, wherein: the 3D composite image represents an external anatomical layer of the object; and the reference image represents a 2D internal anatomical layer.

Clause 7: The method of any of clauses 1 through 6, wherein: the 3D composite image represents an internal anatomical layer of the object; and the reference image represents a 2D external anatomical layer.

Clause 8: The method of any of clauses 1 through 7, wherein rendering the graphical representation includes overlaying the 3D overlay on the composite image.

Clause 9: The method of any of clauses 1 through 8, wherein the set of reference markers includes a plurality of reference markers.

Clause 10: The method of any of clauses 1 through 9, wherein each of the first image capturing device, the second image capturing device, and the third image capturing device are mobile relative to the object.

Clause 11: A system comprising: data processing hardware; and memory hardware in communication with the data processing hardware, the memory hardware storing instructions that when executed by the data processing hardware perform operations comprising: receiving a first image of an object captured by a first image capturing device at a first image capturing location, wherein the first image comprises a first view; receiving a second image of the object captured by a second image capturing device at a second image capturing location, wherein the second image comprises a second view; receiving a third image of the object captured by a third image capturing device at a third image capturing location, wherein the third image comprises a third view; generating a three-dimensional (3D) composite image from the first image, the second image, and the third image; generating a set of 3D reference markers corresponding to features represented by the composite image; obtaining a two-dimensional (2D) reference image representing one or more reference features associated with the features indicated by the reference markers; generating a three-dimensional (3D) overlay of the reference image by aligning the one or more reference feature with locations of the features corresponding to the set of reference markers; and rendering a graphical representation of the composite image with the three-dimensional (3D) overlay, wherein each of first image capturing location, the second image capturing location, and the third image capturing locations are distinct locations that form a convex arc about the object.

Clause 12: The system of clause 11, wherein the first image capturing device comprises the data processing hardware.

Clause 13: The system of any of clauses 11 through 12, wherein at least two of the first image capturing device, the second image capturing device, or the third image capturing device are the same image capturing device.

Clause 14: The system of any of clauses 11 through 13, wherein first image capturing device, the second image capturing device, and the third image capturing device are the same image capturing device.

Clause 15: The system of any of clauses 11 through 14, wherein: the features corresponding to the set of 3D reference markers are features on an external anatomical layer of the object; and the reference features represent an internal anatomical layer.

Clause 16: The system of any of clauses 11 through 15, wherein: the 3D composite image represents an external anatomical layer of the object; and the reference image represents a 2D internal anatomical layer.

Clause 17: The system of any of clauses 11 through 16, wherein: the 3D composite image represents an internal anatomical layer of the object; and the reference image represents a 2D external anatomical layer.

Clause 18: The system of any of clauses 11 through 17, wherein rendering the graphical representation includes overlaying the 3D overlay on the composite image.

Clause 19: The system of any of clauses 11 through 18, wherein the set of 3D reference markers includes a plurality of reference markers.

Clause 20: The system of any of clauses 11 through 19, wherein each of the first image capturing device, the second image capturing device, and the third image capturing device are mobile relative to the object.

A number of implementations have been described. Nevertheless, it will be understood that various modifications may be made without departing from the spirit and scope of the disclosure. Accordingly, other implementations are within the scope of the following claims.

What is claimed is:

1. A method comprising:
receiving, at data processing hardware, a first image of an object captured by a first image capturing device at a first image capturing location, wherein the first image comprises a first view;
receiving, at the data processing hardware, a second image of the object captured by a second image capturing device at a second image capturing location, wherein the second image comprises a second view;
receiving, at the data processing hardware, a third image of the object captured by a third image capturing device at a third image capturing location, wherein the third image comprises a third view;
generating, by the data processing hardware, a three-dimensional (3D) composite image from the first image, the second image, and the third image;
generating, by the data processing hardware, a set of reference markers corresponding to features represented by the composite image;
obtaining, by the data processing hardware, a two-dimensional (2D) reference image representing one or more reference features associated with the features corresponding to the reference markers;
generating, by the data processing hardware, a three-dimensional (3D) overlay of the reference image by aligning the one or more reference features with locations of the features corresponding to the set of reference markers; and
rendering, by the data processing hardware, a graphical representation of the composite image with the three-dimensional (3D) overlay,
wherein each of the first image capturing location, the second image capturing location, and the third image capturing location are distinct locations that collectively form a convex arc about the object.

2. The method of claim 1, wherein the first image capturing device comprises the data processing hardware.

3. The method of claim 1, wherein at least two of the first image capturing device, the second image capturing device, or the third image capturing device are the same image capturing device.

4. The method of claim 3, wherein first image capturing device, the second image capturing device, and the third image capturing device are the same image capturing device.

5. The method of claim 1, wherein:
the features corresponding to the set of reference markers are features on an external anatomical layer of the object; and
the reference features represent an internal anatomical layer.

6. The method of claim 1, wherein:
the 3D composite image represents an external anatomical layer of the object; and
the reference image represents a 2D internal anatomical layer.

7. The method of claim 1, wherein:
the 3D composite image represents an internal anatomical layer of the object; and
the reference image represents a 2D external anatomical layer.

8. The method of claim 1, wherein rendering the graphical representation includes overlaying the 3D overlay on the composite image.

9. The method of claim 1, wherein the set of reference markers includes a plurality of reference markers.

10. The method of claim 1, wherein each of the first image capturing device, the second image capturing device, and the third image capturing device are mobile relative to the object.

11. A system comprising:
data processing hardware; and
memory hardware in communication with the data processing hardware, the memory hardware storing instructions that when executed by the data processing hardware perform operations comprising:
receiving a first image of an object captured by a first image capturing device at a first image capturing location, wherein the first image comprises a first view;
receiving a second image of the object captured by a second image capturing device at a second image capturing location, wherein the second image comprises a second view;
receiving a third image of the object captured by a third image capturing device at a third image capturing location, wherein the third image comprises a third view;
generating a three-dimensional (3D) composite image from the first image, the second image, and the third image;
generating a set of reference markers corresponding to features represented by the composite image;
obtaining a two-dimensional (2D) reference image representing one or more reference features associated with the features corresponding to the reference markers;
generating a three-dimensional (3D) overlay of the reference image by aligning the one or more reference features with locations of the features corresponding to the set of reference markers; and
rendering a graphical representation of the composite image with the three-dimensional (3D) overlay,
wherein each of the first image capturing location, the second image capturing location, and the third image capturing location are distinct locations that collectively form a convex arc about the object.

12. The system of claim 11, wherein the first image capturing device comprises the data processing hardware.

13. The system of claim 11, wherein at least two of the first image capturing device, the second image capturing device, or the third image capturing device are the same image capturing device.

14. The system of claim 11, wherein first image capturing device, the second image capturing device, and the third image capturing device are the same image capturing device.

15. The system of claim 11, wherein:
the features corresponding to the set of reference markers are features on an external anatomical layer of the object; and
the reference features represent an internal anatomical layer.

16. The system of claim 11, wherein:
the 3D composite image represents an external anatomical layer of the object; and
the reference image represents a 2D internal anatomical layer.

17. The system of claim 11, wherein:
the 3D composite image represents an internal anatomical layer of the object; and
the reference image represents a 2D external anatomical layer.

18. The system of claim 11, wherein rendering the graphical representation includes overlaying the 3D overlay on the composite image.

19. The system of claim 11, wherein the set of reference markers includes a plurality of reference markers.

20. The system of claim 11, wherein each of the first image capturing device, the second image capturing device, and the third image capturing device are mobile relative to the object.
